(19) United States
(12) Patent Application Publication
(10) Pub. No.: US 2018/0164157 A1
(43) Pub. Date: Jun. 14, 2018

(54) STREET LIGHT DETECTION

(71) Applicant: Danmarks Tekniske Universitet, Kgs. Lyngby (DK)

(72) Inventors: Henrik Chresten Pedersen, Jyllinge (DK); Henning Engelbrecht Larsen, Ølstykke (DK); Jakob Munkgaard Andersen, Hedehusene (DK)

(21) Appl. No.: 15/577,270

(22) PCT Filed: Jun. 21, 2016
(86) PCT No.: PCT/EP2016/064247

§ 371 Date: Nov. 27, 2017

(30) Foreign Application Priority Data
Jul. 2, 2015 (EP) 15175002.3
May 24, 2016 (DK) PA201670347

(51) Int. Cl. G01J 1/42; H04N 5/232; G01S 19/01; B60Q 1/08

(52) U.S. Cl. CPC G01J 1/4257; H04N 5/23229; B60Q 1/08; G01S 19/01; G01J 1/4228

(57) ABSTRACT

Disclosed is a method, a vehicle and a system for measuring light from one or more outdoor lamps on a road, the system comprising a number of light sensors configured to be arranged in a fixed position relative to a vehicle, where at least a first part of the light sensors is configured for measuring light from the one or more outdoor lamps, wherein at least a second part of the light sensors comprises at least two light sensors configured for detecting the angle which the light from the one or more outdoor lamps arrives at in the second part of the light sensors; a processing unit configured for calculating the position relative to the vehicle of the one or more outdoor lamps based on the detected angle which the light arrives in, and wherein the processing unit is configured for calculating the light on the road based on the light measured in the fixed position relative to the vehicle and based on the calculated position of the one or more outdoor lamps.

### FIELD

The present disclosure relates to a system, a vehicle and a method for measuring light from one or more outdoor lamps on a road.

### BACKGROUND

WO 2007/012839 and the article “Glare, Luminance, and Illuminance Measurements of Road Lightning Using Vehicle Mounted CCD Cameras” by Ashraf Zatari et al. in Leukos: The Journal of Illuminating Engineering Society of North America, 1:2, 85-106 disclose a vehicle-mounted system for measuring road light by means of a CCD camera measuring light from street lamps, such as from three street lamps at a time, providing 3D locations of the street lamps, and another camera measuring light reflected off the road surface.

The Spanish company “Afeisa” markets a vehicle-mounted system for measuring road light called LX-GPS. This system measures the street light at a measurement point at the roof of a car.

The article “Embedded System Design of an Advanced Illumination Measurement System for Highways” by Johnson et al from 2014 in IEEE discloses a lightning measurement system capable of recording illumination reading while travelling at normal driving speed.

WO/2013/186067 by the same inventors as the present invention discloses an illumination control system comprising a plurality of outdoor luminaries and a motorised service vehicle.

CN202916073U discloses a street lamp glare tester comprising a combined light sensor and angle meter. The angle meter may be used to determine the angle of the street light and to determine the location of the street lamp.

WO11001316A1 discloses a method of measuring photometric quantities of runway lights in an airport as well as using a photogrammetric triangulation process to calculate the position of the measuring apparatus, which is a camera and ducted luxmeter, in terms of spatial coordinates.

FR2976662A discloses a method of measuring photometric quantities of street lamps by means of sensors on a motor vehicle. A receiver on the roof of the motor vehicle receives captured light from an upper plane.

WO 90/03094 A1 discloses an apparatus for recording the condition of equipment, such as street lighting, located at spaced positions along a route, comprises a control unit (6) in the form of a personal computer, to which various inputs may be provided. The apparatus also comprises logging means for logging the position of the vehicle in the course of the vehicle's travel along the route, such as a distance transducer (8) adapted to be connected to the vehicle engine. The apparatus also comprises sensing means providing output signals indicating the condition of the equipment being monitored, such as the output of street lamps as the vehicle drives there beneath, the sensing means being in the form of a sensing device (10) comprising an array of photo-sensors, the sensing device (10) being adapted to be mounted on the roof of the vehicle. In use, the vehicle will commence travelling along the route, and output signals will be fed to the control unit (6) both from the distance transducer (8) and the sensing device (10), in a manner in which the output from the sensing device is correlated with the output from the distance transducer. The control unit (6) may be connected to a portable terminal and a printer (16), to produce a print-out indicating the condition of the street lighting along the route.

The prior art systems measure the light at a measurement level or height above the ground, or measure the luminance of the road surface, i.e. the reflection of light from the road surface. There is thus a need for a system which can measure or evaluate the street light at the road for providing exact information of the light as experienced by the people driving on the road.

### SUMMARY

Disclosed is a system for measuring light from one or more outdoor lamps on a road. The system comprises a number of light sensors configured to be arranged in a fixed position relative to a vehicle. At least a first part of the light sensors is configured for measuring light, such as properties of the light, from the one or more outdoor lamps. At least a second part of the light sensors comprises at least two light sensors configured for detecting the angle which the light from the one or more outdoor lamps arrives at in the second part of the light sensors. The system comprises a processing unit configured for calculating the position, such as a three-dimensional, 3D, position, relative to the vehicle of the one or more outdoor lamps based on the detected angle which the light arrives in. The processing unit is configured for calculating the light on the road based on the light measured in the fixed position relative to the vehicle and based on the calculated position, e.g. 3D position, of the one or more outdoor lamps.

Disclosed is also a vehicle configured for driving or moving along a road. One or more outdoor lamps are arranged along the road. The vehicle comprises a number of light sensors, where the number of light sensors is configured to be arranged in a fixed position relative to the vehicle. At least a first part of the light sensors is configured for measuring light from the one or more outdoor lamps. At least a second part of the light sensors comprises at least two light sensors configured for detecting the angle which the light from the one or more outdoor lamps arrives at in the second part of the light sensors. The first part and the second part of the light sensors are configured for providing the measured light and measured angle as input to a system configured for measuring light from the one or more outdoor lamps on the road. The system comprises a processing unit. The processing unit is configured for calculating the position, such as a three-dimensional, 3D, position, relative to the vehicle, of the one or more outdoor lamps based on the detected angle which the light arrives in. The processing unit is configured for calculating the light on the road based on the light measured in the fixed position relative to the vehicle and based on the calculated position, e.g. 3D position, of the one or more outdoor lamps.

Disclosed is also a method for measuring light from one or more outdoor lamps on a road by means of a system for measuring light. The system comprises a number of light sensors, where the number of light sensors is configured to be arranged in a fixed position relative to a vehicle which is configured for driving or moving along the road. The system comprises a processing unit. The method comprises measuring light from the one or more outdoor lamps, by means of at least a first part of the light sensors. The method comprises detecting the angle which the light from the one or more outdoor lamps arrives at in a second part of the light sensors, by means of at least the second part of the light sensors comprising at least two light sensors. The method comprises calculating the position, such as the three-dimensional, 3D, position, of the one or more outdoor lamps based on the detected angle which the light arrives in, by means of the processing unit. The method comprises calculating the light on the road based on the light measured in the fixed position relative to the vehicle and based on the calculated position, e.g. 3D position, of the one or more outdoor lamps, by means of the processing unit.

In order to document that an outdoor lamp or light installation comply with the regulation for illuminance, a measurement system and corresponding method according to the above is needed which can evaluate and prove the light distribution and/or color of the light on a road.

In order to measure the actual light distribution and spectral content on the road, a system can be used as disclosed above which comprises light sensors e.g. on the roof of a vehicle. To be able to use the measured light data for measuring or calculating or computing the light on the road, the exact position of the light source, i.e. the outdoor lamp, relative to the vehicle is calculated or computed as disclosed.

Thus to document the light distribution on the road, the position of the vehicle on the road must be known. It cannot be assumed that the driver of the vehicle drives exactly in e.g. the middle of the road. Thus the vehicle's position must be monitored as it drives. Thus it is an advantage of the present system, vehicle and method that this can be done by placing at least two angle sensitive detectors, i.e. the second part of the light sensors, such as two triangulation sensors on the roof of the vehicle, which can measure the position of the vehicle relative to the outdoor lamp.

The first part of the light sensors may be photo diodes or regular photo detectors which are configured for measuring the light from the one or more outdoor lamps, such as measuring the properties of the light from the outdoor lamps, such as measuring the illuminance, spectral content or color of the light.

Thus it is an advantage that the light measured at the light sensors in the fixed position relative to the vehicle, such as on the roof of the vehicle, can be converted into a measure of the light, such as the illuminance, the spectral content etc, on the road.

Thus the system, vehicle and method provide solutions for the problems of measuring the actual light on the road from outdoors lamps.

The system, vehicle and method can be used to determine the position of the one or more outdoor lamps based on the measuring of the light from the one or more outdoor lamps.

Alternatively and/or additionally, the system, vehicle and method can be used to measure the actual light distribution and spectral content on the road from the one or more outdoor lamps by, among other things, calculating the position, such as a three-dimensional, 3D, position, relative to the vehicle of the one or more outdoor lamps.

Thus the system, vehicle and method can be used for different purposes, for example for a determination of the position of the one or more outdoor lamps, and for example for measuring the actual light distribution and spectral content on the road from the one or more outdoor lamps.

It is an advantage of the present system and method that the second part of the light sensors comprises at least two sensors for detecting the angle(s) which the light from the outdoors lamps arrives in for measuring the position of the vehicle and for measuring the light on the road. Prior art WO 2007/012839 discloses two cameras on the roof of a vehicle, however only one of these cameras is used for determining the position of the road light lamps. This implies that this prior art needs to have at least three lamps in sight in order to calculate the light point on the road. This may not be convenient, as there may not be three lamps in sight at all times. In the present system only one lamp, e.g. outdoor lamp, has to be seen or captured by the system in order to perform the measurements.

It is an advantage of the present system and method that the light sensors measure light above the ground, e.g. above the street level, such as on the roof of the vehicle, because hereby light from the surrounding traffic, e.g. from light or lamps on other vehicles, such as cars, do not disturb the light sensors of the system. When the light sensors are provided or arranged on e.g. the roof of the vehicle, then the light sensors are not impacted or affected by the cones of light from other vehicles driving on the street. If the light sensors where placed at the ground, they would receive a lot of light from e.g. headlights from oncoming traffic, e.g. cars. This light from other cars would be mixed with the light to be measured from the outdoor lamps, and it would be impossible or at least difficult and demanding to separate the light from the various light sources.

It is an advantage that the light distribution and/or color as calculated on the road, can be calculated in any other height or distance, such as in any other height between the road and the position of the light sensors, where the light sensors are e.g. arranged at the roof of the vehicle. In some countries, the law may require that the light distribution and/or color from outdoor lamps on the road is calculated, whereas in other countries the law may require that the light distribution and/or color from outdoor lamps at a certain height above the road is calculated. This height may be e.g. 50 cm, 60 cm, 70 cm or 80 cm above the road. Thus the present system and method can be used to measure the light from e.g. the roof of the vehicle to the road, and/or from e.g. the roof of the vehicle to any other level, such as 70 cm above the road.

The outdoor lamps may be light emitting diode, LED, lamps, i.e. the outdoor lamps may comprise one or more light sources which may be LED light sources. LED lamps change illuminance and color over time, and when LED lamps are installed in outdoor lamps, they will get dirty over time. The present system, vehicle and method can measure these changes of the LED lamps.

The outdoor lamps may be stationary lamps providing artificial light, e.g. street lamps or lamps on a parking place or lamps in a car park or lamps anywhere outdoor, in particular in any physical location where there are regulations or a demand or a wish to be able to measure the actual light on the road or ground from the outdoor lamp, for example because citizens or employees etc. drive or walk or work in these locations, and need to have sufficient lightning, e.g. for safety reasons.

Light from indoor lamps may be measured as well using the system, method and vehicle of the present disclosure.

The processing unit may be configured for calculating or computing the light on the road by correction and/or adjustment of the light measured in the fixed position relative to the vehicle by means of the inverse square law.

The light sensors may be arranged in any configuration in a fixed position on or relative to the vehicle. The at least two light sensors in the second part of the light sensors may be arranged with a distance to each other along a line parallel to the driving direction of the vehicle, or with a distance to each other along a line perpendicular to the driving direction of the vehicle, or with a distance to each other along a line having an angle of less than 90 degrees relative to the driving direction of the vehicle.

The vehicle may be a measurement vehicle or a test vehicle or a service vehicle, such as a car, a bus, a truck, a bicycle, a trailer behind a car, a portable device, a drone etc. configured for moving, such as driving or flying, on or along the road or the outdoor area for measuring the light on the road or ground from the outdoor lamps. A small car or a motorcycle or a bicycle may be small enough to e.g. move along a bicycle track or a footway, e.g. along the road, for measuring the light on the road and not come into conflict with parked cars or driving cars on the road. The vehicle may be a high vehicle or a vehicle with the light sensors arranged high above the road, e.g. with the light sensors arranged on a bar or rod arranged high above the road, since this will allow that the measurement of the light from the outdoor lamps can be measured above parked cars.

Detecting the angle(s) may comprise measuring, sensing, computing, obtaining, providing etc the angle(s). The angle(s) may be detected or measured e.g. by means of triangulation. At least a second part of the light sensors comprises at least two light sensors configured for detecting the angle which the light from the one or more outdoor lamps arrives at in the second part of the light sensors. Thus each of the two light sensors may detect an angle, thus two angles, may be detected. The light sensors are arranged in a fixed position relative to the vehicle, thus the angles are detected relative to this fixed position relative to the vehicle.

The light on the road is calculated or computed based on the light measured in the fixed position relative to the vehicle and based on the calculated or computed position, e.g. 3D position, of the one or more outdoor lamps. The calculation or computation may be based on correlating, proportioning, correcting, adjusting, corrigating, relating etc. the light measured in the fixed position to the road.

Light from the outdoor lamps may be measured when it is dark outside, e.g. during the evening or night, as it may be an advantage to measure the light when the surroundings are dark and the contribution or noise from other light sources is as small as possible.

The light sensors are arranged, or configured to be arranged, in a fixed position. The fixed position may be relative to a vehicle or relative to the outdoor lamp. The fixed position may be a predetermined fixed position. Thus the distance and/or relationship between the light sensors and the outdoor lamp may be known or determined.

When the angles of the incoming light from the outdoor lamp are measured by the angle sensitive detectors or second part of the light sensors, then the intersection point between the two lines or rays of light can be calculated and hereby the position, such as 3D point in space, of the outdoor lamp can be calculated.

The light sensors may be shielded, screened or protected from incoming light from other light sources, such as from car lights from other vehicles driving e.g. in front or behind the vehicle of the system. The shielding, screening or protection may be in the form of shields or screens through which light cannot penetrate and arranged such that the light sensors only or mainly or primarily or substantially only, receive light from the outdoor lamps.

In some embodiments the first part of the light sensors is configured for measuring illuminance and/or spectral content and/or color and/or temperature and/or color rendering index of the light. Thus it is an advantage that the first part of the light sensors may be a regular photo detector measuring various properties of the light from the outdoor lamp. Thus the strength, power, amplitude, illuminance, etc of the light may be measured by the photo detector, i.e. the first part of the light sensor.

In some embodiments the second part of the light sensors comprises a quadro cell comprising an aperture for measuring the angle which the light arrives at. It is an advantage to use a quadro cell or quadro sensor for measuring the angle which the light from the outdoor lamp arrives at, since the quadro cell may measure the angle in both the x- and y-direction, thus allowing determining the position of the vehicle relative to the outdoor lamp in both directions.

In some embodiments the second part of the light sensors comprises an imaging device for measuring the angle which the light arrives at. The imaging device may be a digital imaging device, such as a CMOS sensor or CCD. The imaging device may be an aperture or imaging lens, such as a fish eye lens or a pinhole. The angles of the incoming light may be measured by an imaging device e.g. by providing a mask or a mesh, e.g. at the aperture or opening of the imaging device.

In some embodiments the first part of the light sensors and the second part of the light sensors are the same part. Thus the photo detectors and the angle sensitive detectors may be implemented in the same physical device. It may be an advantage to implement the different parts of the light sensors in the same physical device or unit as it may provide a smaller and more lightweight light sensor which is easier to handle for an operator and easier to replace as only one physical part needs to be replaced, when both parts of the light sensors are configured in the same device or unit. Furthermore, when both parts of the light sensors are implemented in one device or as one device, there may be less physical components which can be damaged and thus potentially cause problems.

In some embodiments the first part of the light sensors and the second part of the light sensors are different parts. Thus the photo detectors and the angle sensitive detectors may be implemented in different physical devices. It may be an advantage to implement the different parts of the light sensors on different physical devices or units, as it may be easy to repair or replace or perform service or maintenance check on the various parts of the light sensors, when they are separated. Furthermore it may be easier to detect any faults on the light sensors when they are implemented in different devices.

In some embodiments the first part and/or the second part of the light sensor are attached or configured to be attached to a bar or rod, and the bar or rod is attached or configured to be attached on or at the vehicle. The bar or rod may be attached at the roof of the vehicle. It is an advantage to attach a bar or rod with the light sensors on the vehicle, as it will be easy to replace or repair or perform service or maintenance check on any light sensors or other parts of the system, such as the processing unit, when the light sensors and e.g. other parts of the system, is attached to the bar or rod and not to the vehicle itself.

The light sensors and/or the bar or rod may be implemented in or comprise a portable unit or mobile unit, which is configured to be mounted and dismounted from the vehicle. The processing unit may also be implemented in the portable unit or mobile unit.

In some embodiments the system comprises a receiver for a space-based satellite navigation system configured for measuring the position of the vehicle. The measurement may be performed continually or at predetermined or regular time intervals. The space-based satellite navigation system or geo-positioning system may be the Global Positioning System, GPS, and the receiver may be a GPS receiver. The GPS receiver may be used for measuring the position of the vehicle or outdoor lamp relative to a map or to a global position to easily present on the map where the vehicle has measured outdoor lamps. The position may be the position of the GPS receiver or antenna on the vehicle and this position may be adjusted to a position of the vehicle and/or to a position of the outdoor lamp which is measured. The position of the vehicle may be or may correspond to or may be represented as or may be understood as the position or location of the light sensors on the vehicle.

The resolution and/or precision and/or accuracy of the measured position may be high, such as higher than a receiver of standard space-based satellite navigation systems, such as a GPS receiver, for ensuring that the position is determined very accurately. The space-based satellite navigation systems may be an enhanced or augmented system, such as a Satellite Based Augmentation System, such as Differential GPS (DGPS) and/or such as Wide-Area DGPS (WADGPS).

The position may be determined within an accuracy and/or precision of about +/−1 meter, such as of about +/−90 cm, such as of about +/−80 cm, such as of about +/−70 cm, such as of about +/−60 cm, such as of about +/−50 cm, such as of about +/−40 cm, such as of about +/−30 cm, such as of about +/−20 cm, or such as of about +/−10 cm.

The receiver of the space-based satellite navigation system may be implemented in the portable unit or mobile unit.

An inertial system, such as an inertial navigation system or inertial guidance system or inertial instrument or inertial measurement unit (IMU) comprising motion sensors, such as accelerometers, and/or rotation sensors, such as gyroscopes, configured to continuously calculate, via dead reckoning, the position, orientation, and/or velocity, such as direction and/or speed of movement, of the vehicle may be added to the navigation system. It is an advantage to add an intertial system to the navigation system, for example in case the satellite connection is disturbed, for example by trees, tall buildings and/or the like, the inertial system can take over the navigation of the vehicle until the satellite connection is re-established.

To further improve the accuracy of the inertial system, the inertial system may be supplemented by a measure of the vehicle's driven distance by means of an odometer in the vehicle and/or by means of a dedicated wheel rotation sensor and/or any other distance sensor.

In some embodiments the system comprises a camera configured for capturing a photo of the one or more outdoor lamps for enabling visual inspection of the one or more outdoor lamps. It is an advantage that at the same time as measuring the light on the road from an outdoor lamp, the outdoor lamp itself, in particular the light source in the outdoor lamp, may be photographed. Afterwards the photo of the outdoor lamp, in particular of the light source in the outdoor lamp, may be inspected by an operator or by a computer program, where it can be detected if the outdoor lamp or if the light source of the outdoor lamp is broken, dirty etc and e.g. needs to be replaced or cleaned. The camera may be implemented in the portable unit or mobile unit.

In some embodiments the system is configured for providing isolux curves associated with the calculated light distribution on the road for each outdoor lamp. Thus the system may be configured for presenting the calculated light on the road for each outdoor lamp as isolux curves. Thus it is an advantage that the system can provide or present or display, such as on a screen on a computer, the result in the form of the calculated light on the road as isolux curves, as this allows an operator to verify whether the light on the road is sufficient and in accordance with regulations.

In some embodiments the system is configured for providing a geomap associated with the calculated light on the road for each outdoor lamp. Thus the system may be configured for presenting the calculated light on the road for each outdoor lamp on a geomap. Thus it is an advantage that the system can provide or present or display, such as on a screen on a computer, the result in the form of the calculated light on the road for each measured outdoor lamp, as this allow an operator to verify whether all outdoor lamps in a specific geographical area, such as on a specific street, has been measured, and also to see the results of the measurements. If the measurement of a specific outdoor lamp shows that the light from this outdoor lamp on the road is not sufficient or not in accordance with regulations, then it is easy for the operator to determine from the map, such as a google earth map, using e.g. the measured GPS position, exactly which outdoor lamp is the problematic one, and then afterwards perform the required repair or replacement of e.g. the light source, such as an LED, in the outdoor lamp.

In some embodiments the system is configured for compensating the calculated light from the outdoor lamp for light from other light sources. The processing unit may e.g. perform this compensation. Light from other light sources may be light from road signs, traffic signals, cars light, advertisements with lights etc. Light from other light sources may be termed stray light or noise. Light from other light sources may be light from artificial light sources such as traffic lights etc and/or it may be light from natural light sources such as from the moon, sun, stars etc. Light from other light sources may be light from a neighbouring outdoor lamp. It is an advantage of using for example a camera as the light sensor that the contribution from each outdoor lamp can be separated, when the outdoor lamps stand close together and their light cones overlap on the street.

In cases where the light beams or cones from neighbouring lamps overlap, it is an advantage to use light sensors which can both detect the angle of the incoming light and detect the illuminance, i.e. it may be a light sensor where the first part of the light sensors and the second part of the light sensors are the same part. Such a light sensor may be a camera, such as a pinhole camera.

In some embodiments the light sensors, such as the first part and/or the second part of the light sensor, are baffled, i.e. they comprise a baffle or screen for separating the individual light sensor in two parts for separating the light contributions from two light sources, such as from two light sources, where one light source is the street lamp to be measured and the other light source may be a neighbor lamp or another vehicle on the road, such as an oncoming vehicle or a vehicle ahead or in front, or such as a vehicle behind.

Thus the light at position x on the road may consists of two contributions: one contribution from a first lamp, e.g. the lamp to be measured, and a second contribution from a second lamp, e.g. a neighbor lamp. These two contributions may not be measured at the same time: the contribution from the first lamp may be measured when the light sensor is at first position whereas the contribution from the second lamp may be measured when the light sensor is at a second position. The two positions of the light sensor may be obtained by the vehicle moving along the road. The light sensor may be separated in two parts by means of a first baffle, so that the light contributions from the two lamps can be separated. In such case light from both lamps can be detected either at the same time or at different times.

A light detector with a second baffle for separating the light sensor into two parts for separating the light contributions from e.g. two lamps may be provided. The second baffle in the light sensor may inhibit unwanted light from e.g. the second lamp to disturb the measurement of the light originating from the first lamp. The second baffle may prevent light from the second lamp to arrive at the light sensor. In such case only light from one of the lamps can be detected at a point in time.

Disclosed is also a method for receiving and processing data. Thus this method regards receiving data and processing of the data. The method may not comprise the gathering of data, such as a step of measuring light from the one or more outdoor lamps, and/or such as a step of detecting the angle which the light from the one or more outdoors lamps arrives at in the light sensors. The processed data may be used for determining light from one or more outdoor lamps on a road by means of a system for measuring light. The system comprises a number of light sensors, where the number of light sensors is configured to be arranged in a fixed position relative to a vehicle which is configured for driving or moving along the road. The system comprises a processing unit. The method comprises receiving measured light from the one or more outdoor lamps, by means of at least a first part of the light sensors. The method comprises receiving a detected angle which the light from the one or more outdoor lamps arrives at in a second part of the light sensors, by means of at least the second part of the light sensors comprising at least two light sensors. The method comprises calculating the position, such as the three-dimensional, 3D, position, of the one or more outdoor lamps based on the detected angle which the light arrives in, by means of the processing unit. The method comprises calculating the light on the road based on the light measured in the fixed position relative to the vehicle and based on the calculated position, e.g. 3D position, of the one or more outdoor lamps, by means of the processing unit.

The present invention relates to different aspects including the system described above and in the following, and corresponding system parts, methods, devices, vehicles, networks, kits, uses and/or product means, each yielding one or more of the benefits and advantages described in connection with the first mentioned aspect, and each having one or more embodiments corresponding to the embodiments described in connection with the first mentioned aspect and/or disclosed in the appended claims.

### BRIEF DESCRIPTION OF THE DRAWINGS

The above and other features and advantages will become readily apparent to those skilled in the art by the following detailed description of exemplary embodiments thereof with reference to the attached drawings, in which:

FIG. 1 schematically illustrates an exemplary system for measuring light from one or more outdoor lamps on a road,

FIG. 2 schematically illustrates an exemplary second part of the light sensors in the form of a quadro cell or quadro photo detector,

FIG. 3 schematically illustrates an exemplary measurement principle for measuring and calculating the light on the road,

FIG. 4 schematically illustrates an exemplary embodiment of the light sensors,

FIG. 5 schematically illustrates an exemplary embodiment of the light sensors.

FIG. 6 schematically illustrates a grid of light sensors,

FIG. 7 schematically illustrates an extended bar comprising light sensors,

FIG. 8 schematically illustrates an extended bar comprising light sensors,

FIG. 9 schematically illustrates a side mounted extension of a bar comprising light sensors,

FIG. 10 schematically illustrates an example of signal processing of pulsating light,

FIG. 11 schematically illustrates how an imaging device measures the angle α of the incoming light from an outdoor lamp,

FIG. 12 schematically illustrates an example of compensating the calculated light from the outdoor lamp for light from other light sources, such as from a neighbour outdoor lamp,

FIG. 13 schematically illustrates an example of an isolux curve.

FIG. 14a)-14b) schematically illustrates examples of baffled light sensors separated in two parts for separating the light contributions from two light sources, such as two street lamps.

### DETAILED DESCRIPTION

Various embodiments are described hereinafter with reference to the figures. Like reference numerals refer to like elements throughout. Like elements will, thus, not be described in detail with respect to the description of each figure. It should also be noted that the figures are only intended to facilitate the description of the embodiments. They are not intended as an exhaustive description of the claimed invention or as a limitation on the scope of the claimed invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

Throughout, the same reference numerals are used for identical or corresponding parts.

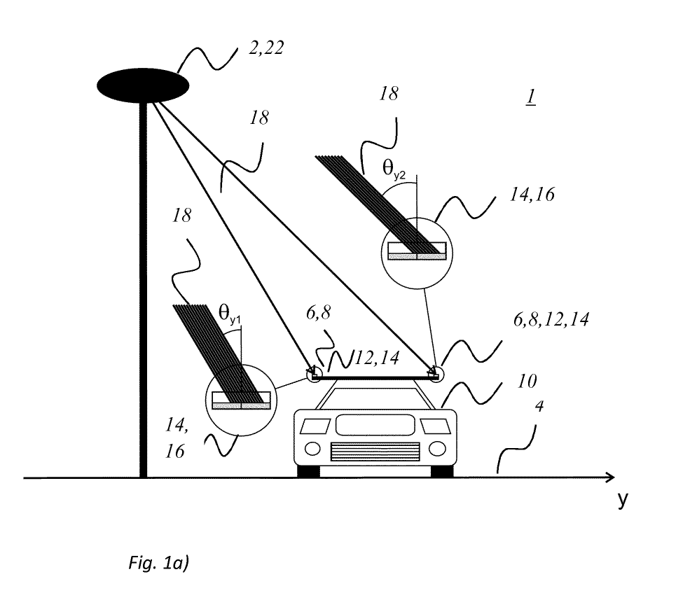

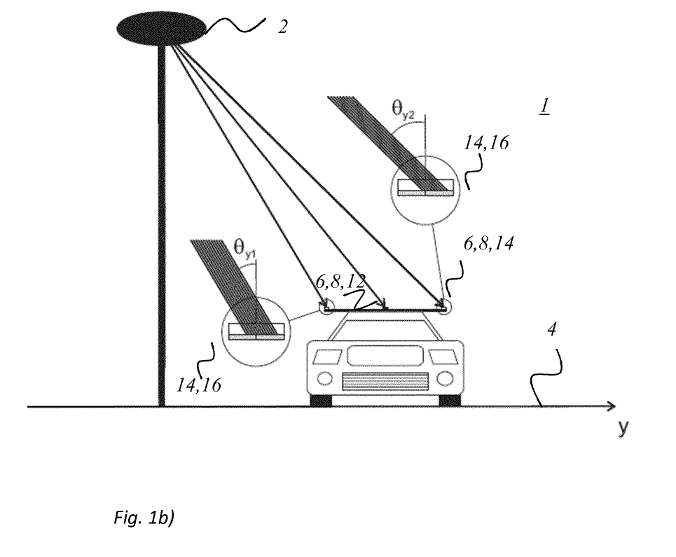

FIG. 1a) schematically illustrates a system 1 for measuring light from one or more outdoor lamps 2 on a road 4. The system 1 comprises a number of light sensors 6 configured to be arranged in a fixed position 8 relative to a vehicle 10. The light sensors 6 may comprise regular photo detectors 12 for measuring properties of the light 18 from an outdoor lamp 2, such as the illuminance. These sensors 12 may be called first part of the light sensor 6. The light sensors 6 may also comprise angle-sensitive detectors 14 for measuring the angle(s) which the light 18 from the outdoor lamps 2 arrives at. These sensors 14 may be called second part of the light sensors 6. The photo detectors 6 or first part 12 of the light sensor 6 and the angle-sensitive 14 or second part 14 of the light sensors 6 may be physically implemented in one unit as shown on FIG. 1a).

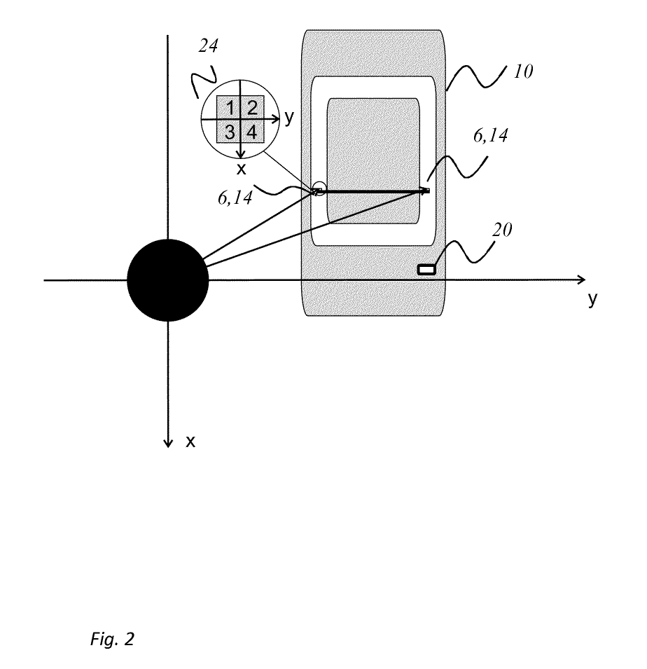

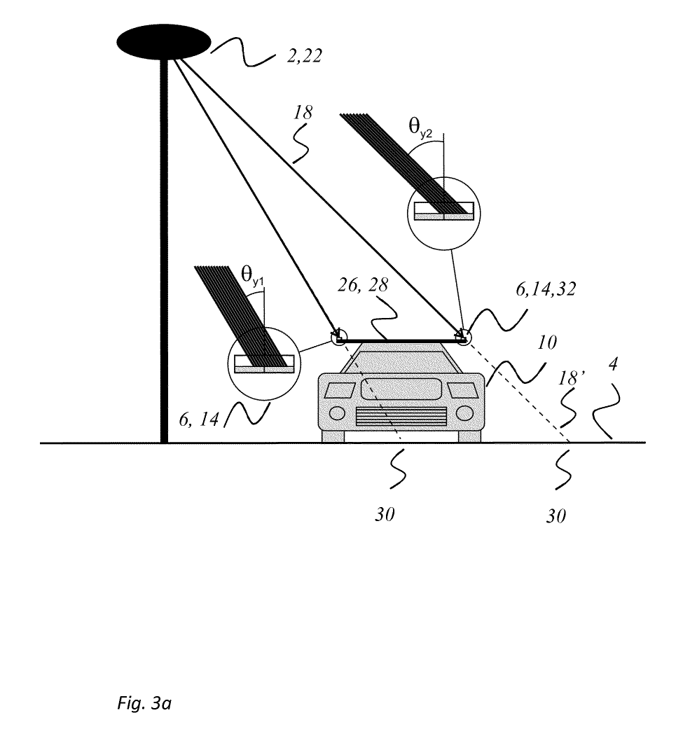

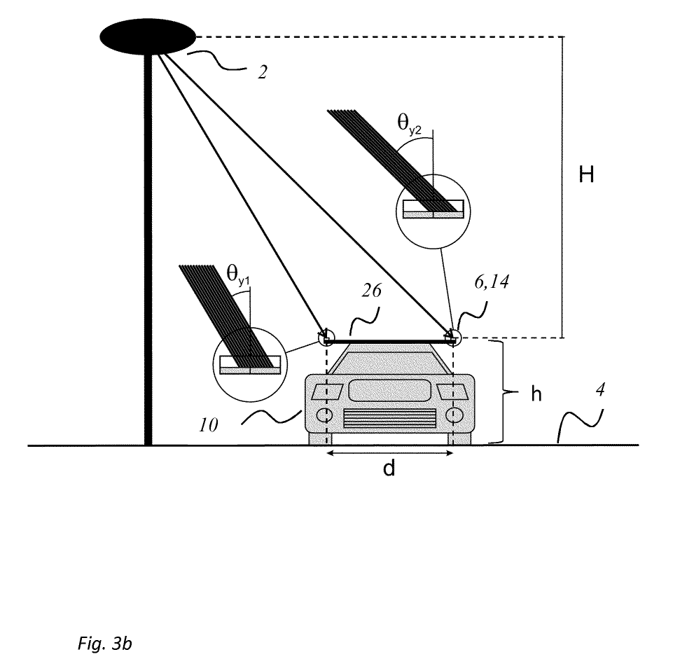

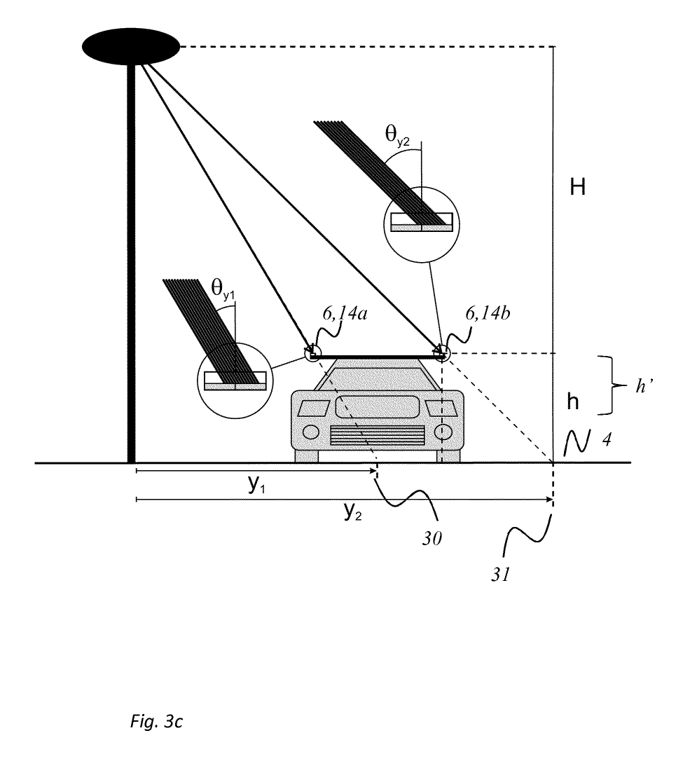

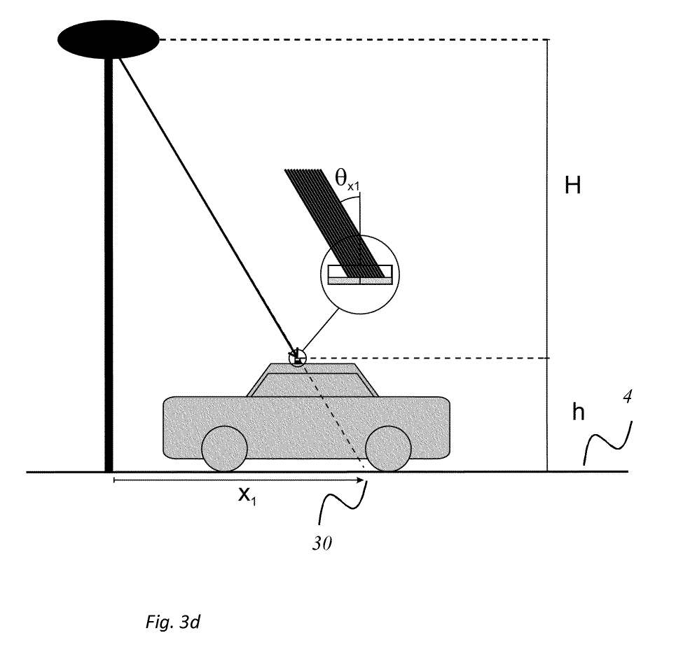

Thus at least a first part 12 of the light sensors 6 is configured for measuring light from the one or more outdoor lamps 2. At least a second part 14 of the light sensors 6 comprises at least two light sensors 16 configured for detecting, measuring or calculating or computing the angle θy1 and the angle θy2 which the light 18 from the one or more outdoor lamps 2 arrives at in the second part 14 of the light sensors 6. The circles are enlargements of the second part 14 of the light sensors 6 showing the angles θy1 and the angle θy2 which the light 18 arrives at. The first part 12 and the second part 14 of the light sensors 6 are configured as the same physical part. The system 1 comprises a processing unit (not shown) configured for calculating or computing the 3D position 22 relative to the vehicle 10 of the one or more outdoor lamps 2 based on the detected angles θy1 and θy2 which the light 18 arrives in. An example of how the calculation or computation of the 3D position can be performed is explained and shown in connection with for example FIG. 2 and FIG. 3d. The processing unit is configured for calculating or computing the light on the road 4 based on the light measured in the fixed position 8 relative to the vehicle 10 and based on the calculated or computed 3D position 22 of the one or more outdoor lamps 2.

Thus the two angle sensitive detectors 14, i.e. the at least two light sensors of the second part 14 of the light sensors 6, are used for i) computing the position of the outdoor lamp 2 relative to the vehicle 10, and ii) based on this computed position of the outdoor lamp 2 the light 18 from the outdoor lamp 2 on the road 4 can be measured, e.g. the position and the illuminance of the light on the road, where the light 18 is detected using a regular photo detector 12 or the first part 12 of the light sensor 6 on or relative to the vehicle 10.

The processing unit may be configured in the same unit as the light sensors 6. The processing unit may be configured in the vehicle 10. The processing unit may be configured in a computing device, such as a computer or FPGA, arranged separately from or integrated with the light sensors and/or separately from or integrated with the vehicle 10. The computing device may be a computer configured to be arranged in an office facility.

Thus the light sensors 14 detecting the angle which the light arrives at may be termed angle sensitive sensors or detectors or triangulation sensors. By determining the angles θy1 and θy2 the position of the light source 2 relative to the vehicle 10 can be computed. Each sensor 14 may determine the angle based on the imbalance in illuminance between the two shown detector cells, seen in the enlargements. If the detectors instead are separated in four, such as a quadro cell, i.e. detectors which are also separated along the driving direction, the position in the driving direction of the vehicle, when the vehicle drives along a road or in an outdoor area, such as a parking lot, can also be determined.

The first part 12 and the second part 14 of the light sensors 6 are here shown as being implemented in one unit. At least two light sensors 16 of the second part 14 and of the first part 12 of the light sensors are shown and this allows two detectors or light sensors to measure two angles θy1 and θy2 and two illuminances.

The second part of the light sensors 14 are here shown as quadro photo detectors with an aperture in front.

The first part and the second part of the light sensors can be implemented as one unit, e.g. as a quadro sensor or as a quadro photo detector. The angles θy1 and θx1 which the light arrives at in the angle-sensitive detectors, i.e. in the second part of the light sensor, can be measured using the equation:

Tan(θy1)=k1*[(I2+I4)−(I1+I3)]/(I1+I2+I3+I4)

Tan(θx1)=k1*[(I3+I4)−(I1+I2)]/(I1+I2+I3+I4)

where k1 is a first calibration factor and I1-I4 are the measured light signals from detector cells 1-4, respectively.

The illuminance, I, can be measured using the equation:

I=k2(I1+I2+I3+I4),

where k2 is a second calibration factor.

Thus one physical entity, the light sensor, e.g. in the form of a quadro sensor, can measure both the angles which the light arrives at, and measure parameters of the light, e.g. the illuminance, thus functioning both as an angle-sensitive detector, i.e. the second part of the light sensor, and as a regular photo detector, i.e. the first part of the light sensor, measuring properties of the light.

FIG. 1b) schematically illustrates a system 1 for measuring light from one or more outdoor lamps 2 on a road 4 as the system shown in FIG. 1a). The system 1 comprises a number of light sensors 6 configured to be arranged in a fixed position 8 relative to a vehicle 10. At least a first part 12 of the light sensors 6 is configured for measuring light from the one or more outdoor lamps 2. At least a second part 14 of the light sensors 6 comprises at least two light sensors 16 for measuring the angles which the light from the outdoor lamps arrives at. The first part 12 and the second part 14 of the light sensors 6 are configured as different physical parts.

FIG. 2 illustrates a quadro cell 24 or quadro photo detector on the vehicle 1 as an exemplary second part 14 of the light sensors 6. The quadro cell 24 allows for determining the position in two dimensions, i.e. in both the x direction and in the y direction, illustrated by the x-axis and the y-axis. The position of the vehicle relative to the position of the outdoor lamp can hereby be determined, also in the driving direction of the vehicle, when the vehicle drives along the road.

The measurement is performed as:

Tan(θy1)=k1*[(I2+I4)−(I1+I3)]/(I1+I2+I3+I4) and

Tan(θx1)=k1*[(I3+I4)−(I1+I2)]/(I1+I2+I3+I4)

where k1 is a first calibration factor and I1-I4 are the measured light signals from detector cells 1-4, respectively.

The illuminance in the measurement position, e.g. on the roof of the vehicle, is given by I=k2(I1+I2+I3+I4), where k2 is a second calibration factor

As an alternative to using a quadro cell 24, a camera chip can be used, for example a CMOS sensor. Using a CMOS sensor may require less alignment, as the four quadro zones can be defined electronically in a CMOS sensor.

The processing unit 20 may be implemented as shown in the figure on the vehicle 10. The processing unit may be arranged in the light sensor 6, such as in the second part 14 of the light sensor.

FIG. 3a schematically illustrates a measurement principle, where, based on two measurements of the angle(s), θy1 and θy2, which the light from the outdoor lamps 2 arrives at in the angle sensitive detectors, i.e. the second part 14 of the light sensor 6, on the roof 26, such as on a bar 28 on the roof 26, of the vehicle 10, illuminances and positions 30 of the light 18′ on the road 4 can be computed.

The positions 30 as shown here may be relative to the position 22 of the outdoor lamp 2. This kind of indication of the position 30 of the light on the road relative to the position 22 of the outdoor lamp may be sufficient in some cases.

In other cases, the indication of the position 30 of the light on the road may be provided in terms of a global positioning system (GPS) position. In such cases, a GPS receiver 32 may be arranged in or on the vehicle 10. The GPS receiver 32 may for example be arranged at the light sensor 6. The positions 30 of the light 18′ on the road 4 will then be provided as GPS coordinates. Hereby the position 22 of the outdoor lamp 2 may also be provided in GPS coordinates.

Some users of the system, e.g. municipalities, would be interested in obtaining the positions in GPS coordinates, since hereby all the outdoor lamps in a municipality can be registered in a database, and if the position of an outdoor lamps is known, the position of the light source in the outdoor lamp can then be computed relative to the position of the outdoor lamp and this would reveal if the outdoor lamps is skew or uneven relative to an ideal vertical positioning. It is a problem that outdoor lamps are blown or pushed askew over time.

FIG. 3b schematically illustrates that first the height H of the outdoor lamp 2 above the angle sensitive detectors, i.e. the second part 14 of the light sensor 6, is measured. In the figure the angle sensitive detectors, i.e. the second part 14 of the light sensors 6, is/are placed on the roof 26 of the vehicle 10. The height H is calculated by:

H=W[Tan(θy2)−Tan(θy1)],

where d is a known projected y-distance between the two angle sensitive detectors.

FIG. 3c schematically illustrates that the height H is used to calculate the light points or positions, y1 and y2, 30 on the road 4 as:

y1=(H+h)Tan(θy1),

y2=(H+h)Tan(θy2).

From this the illuminance (Lux) at point y1, 30 on the road 4 can be calculated based on the illuminance measured at one angle sensitive detector, i.e. a first detector 14a of the second part 14 of the light sensor 6, as:

Illuminance at y1 on the road=Illuminance at first detector of second part of light sensor*Ĥ2/(h+H)̂2,

where h is the height of the roof 26 of the vehicle 10 above the road 4.

Likewise the illuminance (Lux) at point y2, 31 on the road 4 can be calculated based on the illuminance measured at another angle sensitive detector, i.e. at a second detector 14b of the second part 14 of the light sensor 6, as:

Illuminance at y2 on the road=Illuminance at second detector of second part of light sensor*Ĥ2/(h+H)̂2,

where h is the height of the roof 26 of the vehicle 10 above the road 4.

Thus the present system and method can be used to measure the light from e.g. the roof of the vehicle to the road, and/or from e.g. the roof of the vehicle to any other level, such as 70 cm above the road. The height h is then replaced with the reduced height h′ in the equations above, such that the light can be measured e.g. 70 cm above the road. Thus h′ is the height difference between the roof of the vehicle, where the light sensors are configured to be arranged, and the desired measurement level or height above the ground.

FIG. 3d) schematically illustrates how the position of the light points on the road 4 in the driving direction, i.e. the x coordinate, is calculated. The position x1 as calculated for one light sensor, such as for the first detector 14a of the second part 14 of the light sensor 6, is:

x1=(H+h)Tan(θx1)

A corresponding equation applies for another light sensor, such as for a second detector 14b of the second part 14 of the light sensor 14.

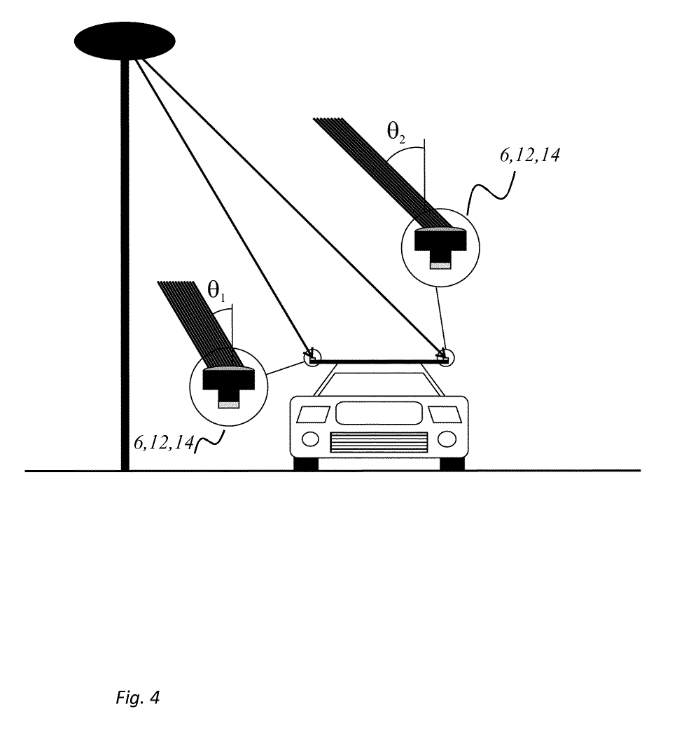

FIG. 4 schematically illustrates an exemplary embodiment of the light sensors 6, where the light sensor 6 is a camera 34 with optics, e.g. a pinhole or a fish-eye lens. Such light sensor 6 will typically have a greater viewing angle than the quadro cell or sensor shown, which may be an advantage in some cases. The light sensor 6 in the form of the camera 34 may comprise both the first part 12, i.e. the photo detectors, and the second part 14, i.e. the angle sensitive detectors, of the light sensor 6.

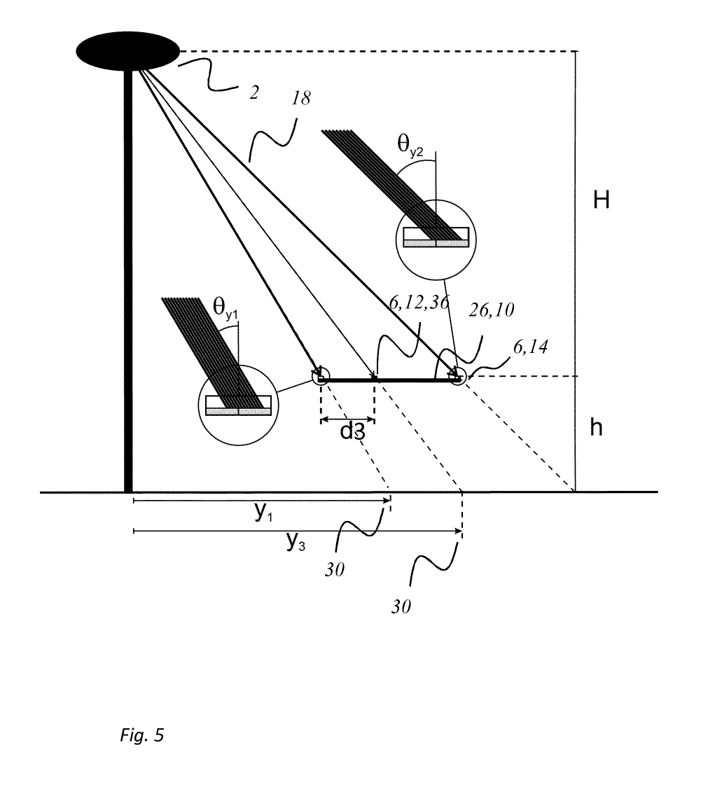

FIG. 5 schematically illustrates an embodiment where more or extra 36 first parts 12 of the light sensors 6 are arranged for measurement of the light 18 from the outdoor lamp 2. Hereby more measurement points will be obtained. These extra 36 first part 12 light sensors do not have to be angle sensitive like the second part of the light sensors. The first part 12 light sensors can be regular photo detectors. The illuminance is again determined by the equation:

Illuminance on the road=illuminance at the light sensor*Ĥ2/(h+H)̂2,

where H is the height of the outdoor lamp 2 relative to the roof 26 of the vehicle 10, and h is the height of the roof 26 of the vehicle relative to the road 4.

With regards to determining the position of the light point 30 in the y direction, the position y3 can be calculated from the equation:

y3=y1+d3(1+h/H),

where d3 is the projected y-distance between detector 1 and 3.

Likewise, for the determination of the position 30 in the x direction, the position x3 can be calculated as:

x3=x1+d3′(1+h/H),

where d3′ is the projected x-distance between detector 1 and 3.

Advantages of using photo detectors instead of a camera are that photo detectors typically have a greater dynamical range of measurement, photo detectors are faster, i.e. they can sample faster, and the signal is easier to process, e.g. using filters such as noise filters, which can average any pulsating light sources.

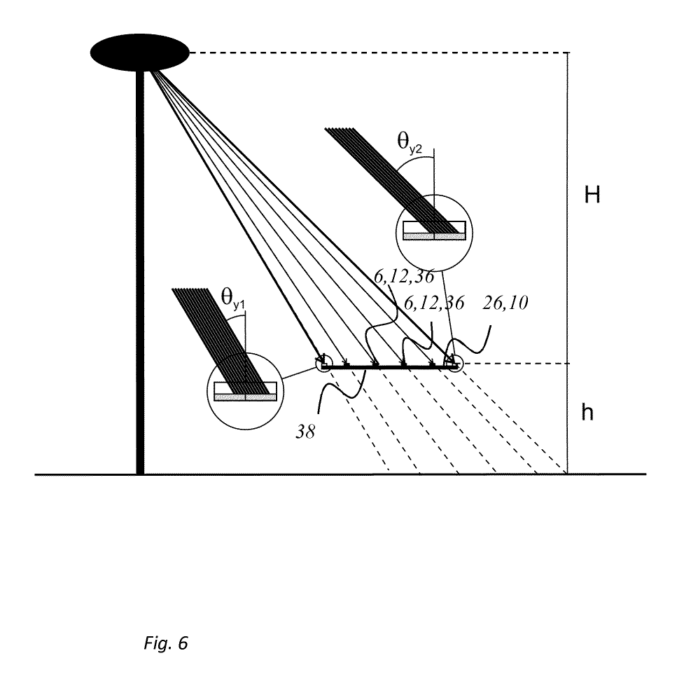

FIG. 6 schematically illustrates a grid 38 of first part 12 of light sensors 6 or extra 36 light sensors or detectors used to obtain more measurement points. The grid 38 may be arranged on the roof 26 of the vehicle 10.

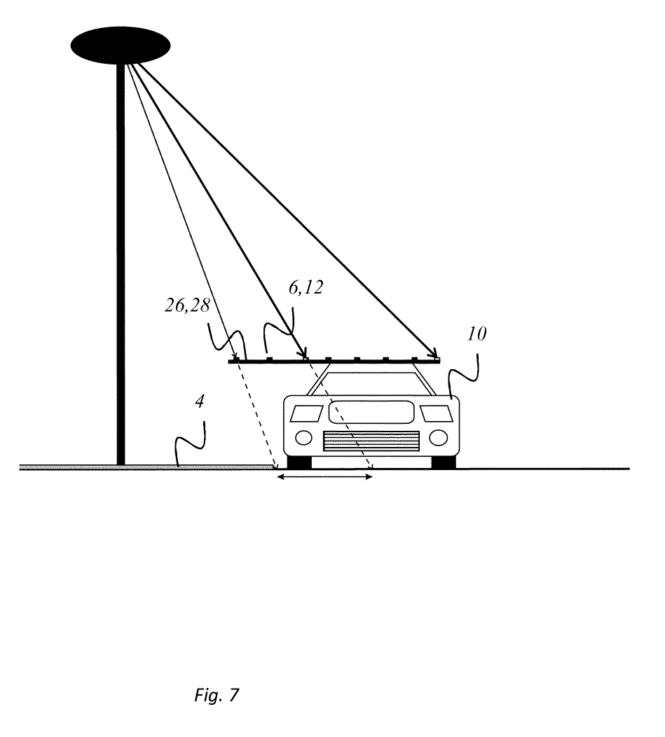

FIG. 7 schematically illustrates a bar 28 comprising light sensors 6, such as photo detectors or first part 12 of light sensors 6, on the roof 26 of the vehicle 10 which is extended, e.g. in the y direction, such that the light on the road 4 can be measured also at or proximate to the pavement or sidewalk.

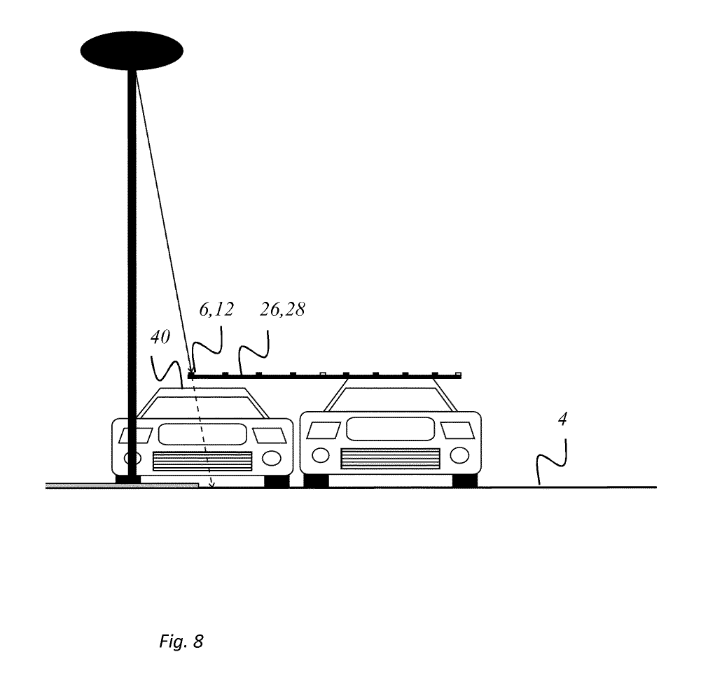

FIG. 8 schematically illustrates a bar 28 comprising light sensors 6, such as photo detectors or first part 12 of light sensors 6, on the roof 26 of the vehicle which is extended such that the light on the road 4 can be calculated under for example parked cars 40.

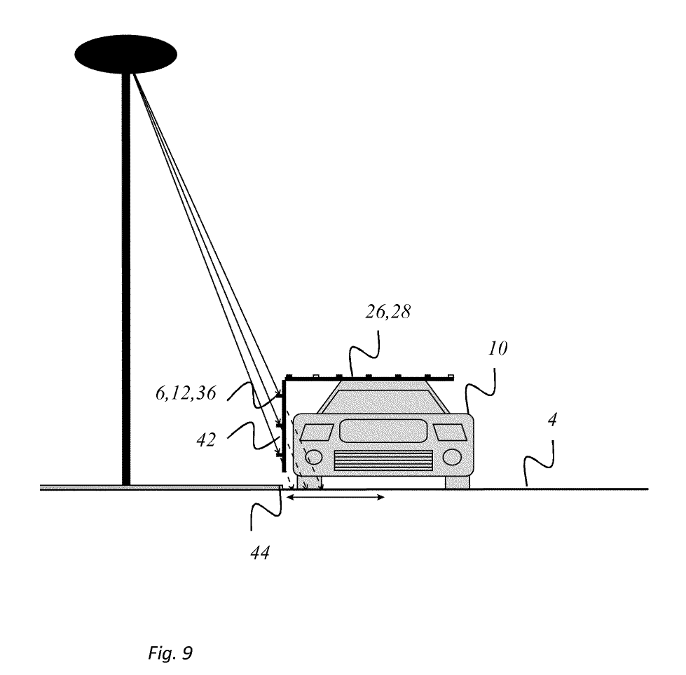

FIG. 9 schematically illustrates a side mounted extension 42 of the bar 26 on the roof 28 of the vehicle 10 with one or more light sensors 6, such as first part 12 of the light sensor 6 in the form of extra light sensors 36 arranged in a vertical position. The side mounted extension 42 provides that the light on the road 4 can be calculated for example as far as at the roadside 44.

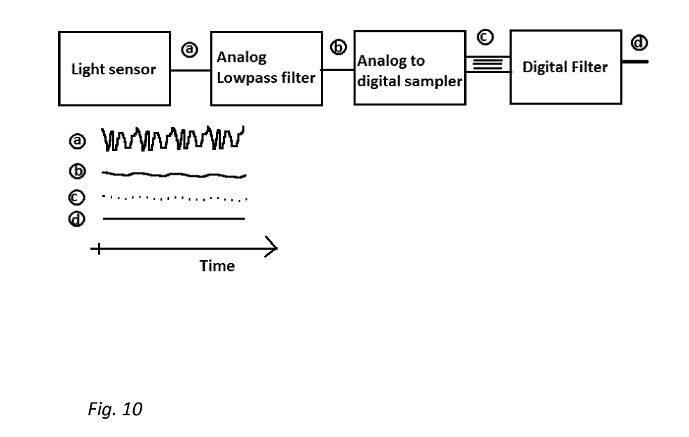

FIG. 10 schematically illustrates an example of signal processing of pulsating light with example time domain signal shapes at the different stages, and the resulting signal for each stage or processing step indicated as a, b, c, and d.

Some outdoor lamps, such as streetlamps, do not emit a constant light intensity but rather a pulsating light with from 100 Hz to some kHz of frequency. Modern LED lamps have built-in electronics which may generate pulsations of varying frequencies as opposed to for instance incandescent lamps which pulsate with a frequency given by the power-grid.

In order to correctly measure the light intensity of such pulsating light, the sensor signal may be time-averaged before the sampling, i.e. the recording of the light intensity. This time averaging can be done for example:

i) over a time interval equal to an integer number of the pulsation period; or

ii) over a sufficiently large time interval relative to the pulsating period such that inclusion of only a fraction of a period into the average does not alter the result significantly.

Method i) may need information about the exact pulsation period. Method ii) may need longer measurement time.

Averaging of the light sensor signal (a) of FIG. 10 can be done either in continuous time (analog) or in discrete time domain (digital). In the latter case the sampling period may be significantly smaller than the pulsating period to prevent that aliasing effects will occur, and an accurate averaging may not be possible. A typical solution in this case is to low-pass filter (smoothing or averaging) the signal using a continuous time filter, removing the portion of the signal which could produce aliasing resulting in the signal (b) of FIG. 10 and then sample this filtered signal in the discrete time domain resulting in the signal (c) of FIG. 10. The samples are subsequently filtered with a digital averaging filter which can be implemented with very precise characteristics with respect to amplitude and time response resulting in the signal (d) of FIG. 10.

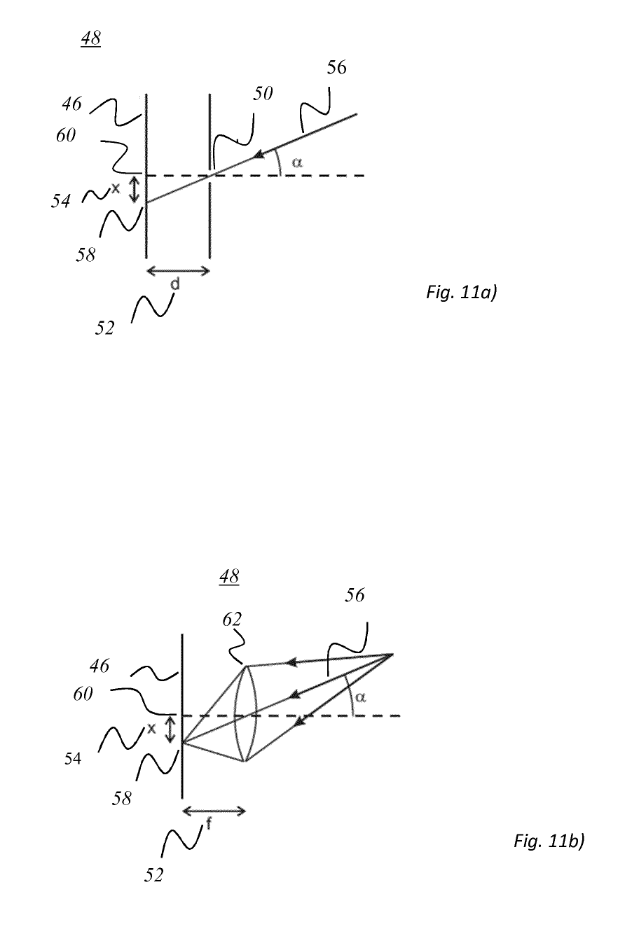

FIG. 11 schematically illustrates how an imaging device 46, such as a CCD or CMOS sensor can measure the angle α of the incoming light from an outdoor lamp.

FIG. 11a) shows how the angle α is measured in a pinhole camera 48 having a pinhole 50. The light ray 56 from the outdoor lamp is incident on the CMOS sensor 46 with an angle α through the pinhole 50. Based on the known distance d 52 between the pinhole and the CMOS sensor and the distance x 54 between the position of the incident light spot 58 and the normal 60 at the CMOS sensor 46, the angle α can be determined as tan(α)=x/d.

FIG. 11b) shows how the angle α is measured in a lens camera 48 having a lens 62. The light ray 56 from the outdoor lamp is incident on the CMOS sensor 46 with an angle α through the lens 62. Based on the known focus f, i.e. distance 52, between the lens and the CMOS sensor and the distance x 54 between the position of the incident light spot 58 and the normal 60 at the CMOS sensor 46, the angle α can be determined as tan(α)=x/f.

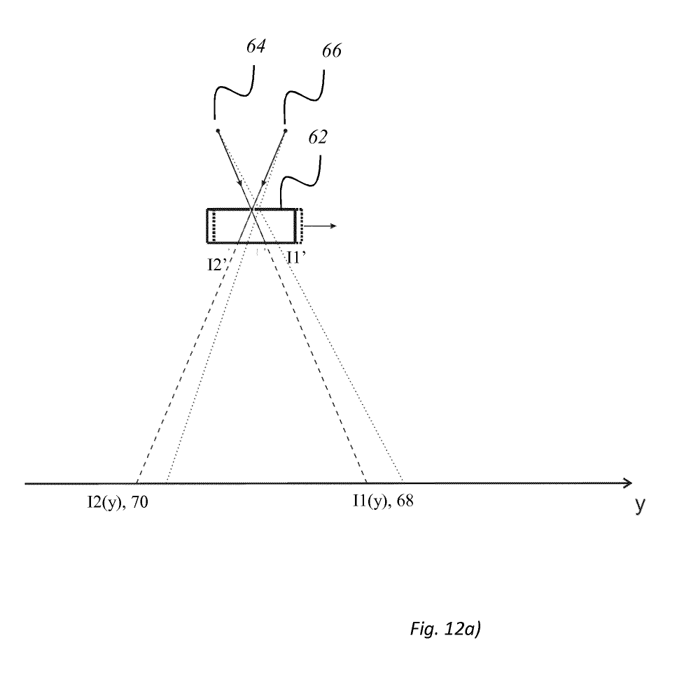

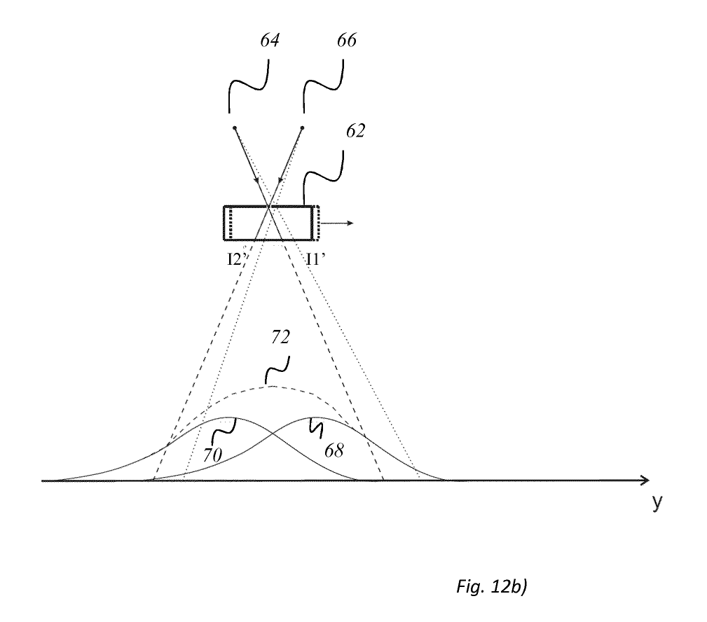

FIG. 12 schematically illustrates an example of compensating the calculated light from the outdoor lamp for light from other light sources, such as from a neighbour outdoor lamp. Thus in cases where the light beams or cones from neighbouring lamps overlap, it is an advantage to use light sensors which can both detect the angle of the incoming light and detect the illuminance, i.e. it may be a light sensor where the first part of the light sensors and the second part of the light sensors are the same part. Such a light sensor may be a pinhole camera.

FIG. 12a) shows an example where the pinhole camera 62 detects two spots originating from the two lamps 64 and 66. One spot, originating from lamp 64, has a measured strength/intensity of I1′, as shown in the figure. One spot, originating from lamp 66, has a measured strength/intensity of I2′, as shown in the figure. By using a calibration constant and the inverse square law as mentioned previously, the corresponding light points, i.e. illuminance and position, on the road I1(y) 68 and I2(y) 70 can be calculated. As the vehicle (not shown) moves, a number of light points are calculated. By using interpolation, these light points can be converted into two light curves I1(y) 68 and I2(y) 70, shown in FIG. 12b). By adding these two curves, the total illuminance I(y) 72 is obtained, i.e. Iy(1)+I2(y)=I(y).

A similar interpolation technique may be used in two-dimensions (2D), in which a series of light points I1(x,y) and I2(x,y), measured by several detectors, may be converted into non-discrete light functions I1(x,y) and I2(x,y). These are also added to give the final illumination distribution I(x,y)=I1(x,y)+I2(x,y).

A similar result can be obtained using lens cameras.

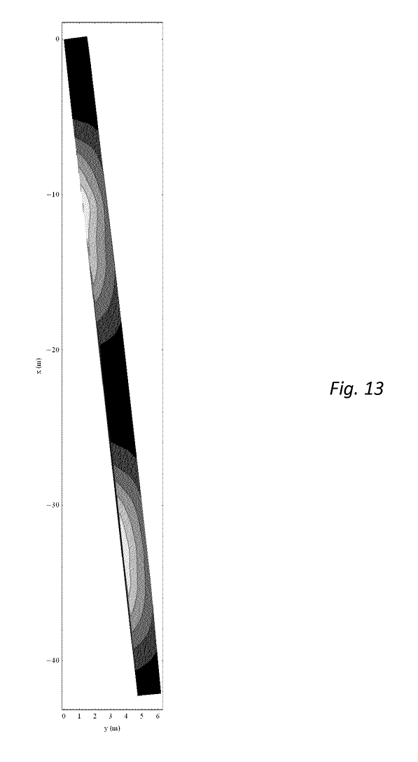

FIG. 13 schematically illustrates an example of an isolux curve. Based on the illuminance data, e.g. obtained as disclosed above, the illuminance can be presented in the form of isolux curves as shown in the figure. The figure shows exemplary isolux curves shown as a function of transverse and longitudinal coordinates (x,y) in metres.

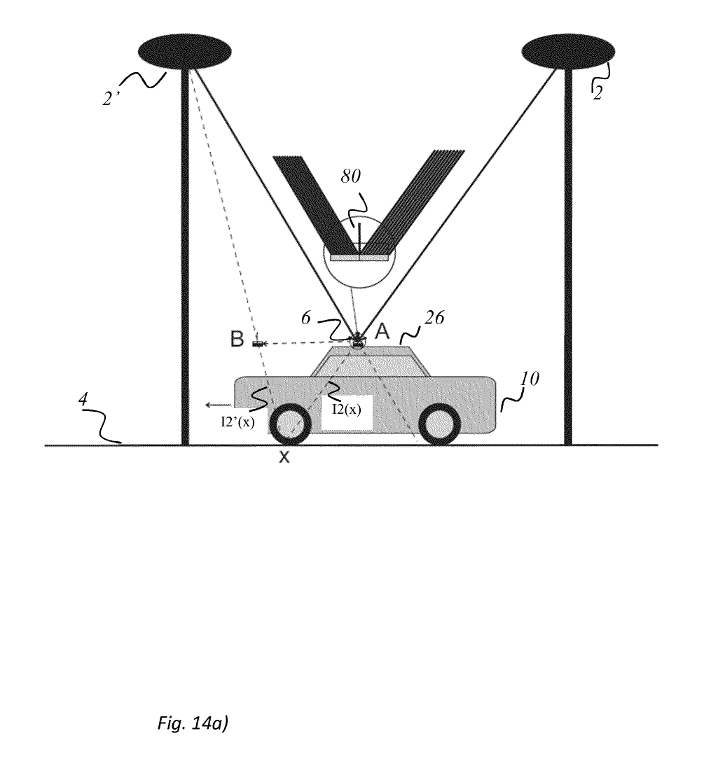

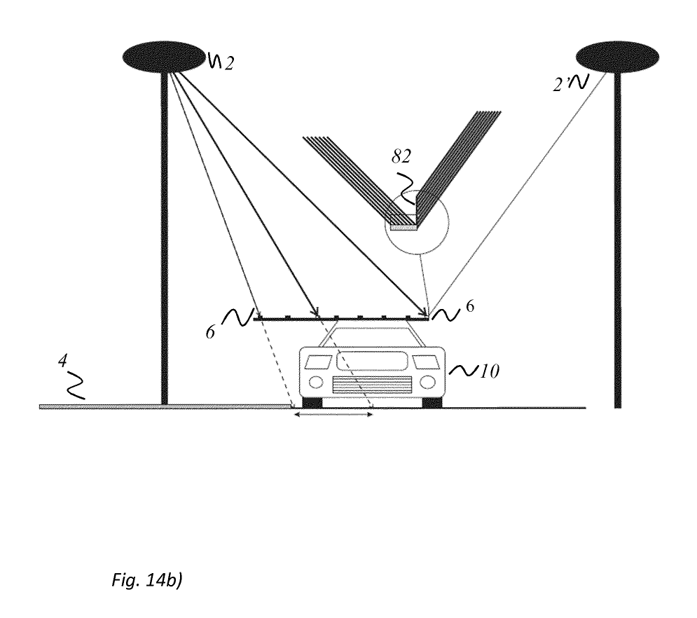

FIG. 14a)-14b) schematically illustrates examples of baffled light sensors 6 separated in two parts for separating the light contributions from two light sources, such as two street lamps 2, 2′.

FIG. 14a) illustrates calculating the light on the road 4, based on measurements of the light performed at roof level 26 of the vehicle 10. As is seen, the light at position x on the road 4 consists of two contributions: one contribution from a first lamp 2 and a second contribution from a second lamp 2′. These two contributions are not measured at the same time: the contribution from the first lamp 2 is measured when the light sensor 6 is at position A whereas the contribution from the second lamp 2′ is measured when the light sensor 6 is at position B. The light sensor 6 is separated in two parts by means of a first baffle 80, so that the light contributions from the two lamps, 2, 2′, can be separated.

The total illuminance I(x) is the light contribution I2(x) from lamp 2 added with the light contribution I2′(x) from lamp 2′:

I(x)=I2(x)+I2′(x)

FIG. 14b) illustrates an example of a baffled light sensor 6 for separating the light sensor 6 into two parts for separating the light contributions from two lamps 2, 2′ or from separating the light contributions from other vehicles etc.

FIG. 14b) shows a light detector 6 with a second baffle 82 for separating the light sensor 6 into two parts for separating the light contributions from e.g. two lamps 2, 2′. The second baffle 82 in the light sensor 6 inhibits unwanted light from e.g. a second lamp 2′ to disturb the measurement of the light originating from the first lamp 2. The baffle 82 prevents light from the second lamp 2′ to arrive at the light sensor 6.

Although particular features have been shown and described, it will be understood that they are not intended to limit the claimed invention, and it will be made obvious to those skilled in the art that various changes and modifications may be made without departing from the scope of the claimed invention. The specification and drawings are, accordingly to be regarded in an illustrative rather than restrictive sense. The claimed invention is intended to cover all alternatives, modifications and equivalents.

### LIST OF REFERENCES

1 system
2, 2′ outdoor lamps
4 road
6 number of light sensors
8 fixed position relative to a vehicle
10 vehicle
12 first part of the light sensors
14 second part of the light sensors
14a first detector of second part of light sensors
14b second detector of second part of light sensors
16 at least two light sensors of the second part of the light sensors
θy1 first angle which the light from the one or more outdoor lamps arrives at in the second part of the light sensors
θy2 second angle which the light from the one or more outdoor lamps arrives at in the second part of the light sensors
18 light from the one or more outdoor lamps
18′ light from the one or more outdoor lamps on the road
20 processing unit
22 three-dimensional (3D) position relative to the vehicle of the one or more outdoor lamps
24 quadro cell as light sensor
26 roof of vehicle
28 bar on roof of vehicle
30 position(s) of light from outdoor lamp on road
31 position of light from outdoor lamp on road
32 GPS receiver
34 camera with optics as light sensor
36 extra light sensors of first part 12 of light sensors 6
38 grid of extra light sensors
40 parked car
42 side mounted extension
44 roadside
H height between roof of vehicle and outdoor lamp
h height of roof of vehicle above road
h′ reduced height, any or arbitrary height between roof of vehicle and road
y1,y2,y3 positions of light on road in the y direction
x1,x2,x3 positions of light on road in the x direction
46 CMOS or CCD
48 camera
50 pinhole
52 distance d between pinhole and CMOS
54 distance x between light spot and projected position of pinhole
56 light ray
58 light spot
60 projected position of pinhole on sensor
62 pinhole camera
64 street lamp
66 street lamp
68 light point on the road from lamp 64
70 light point on the road from lamp 66
I1(y) light point and curve from lamp 64
I2(y) light point and curve from lamp 66
72 total illuminance I(y) from I1(y) and I2(y)
80 first baffle
82 second baffle

1. A system for measuring light from one or more outdoor lamps on a road, the system comprising:
a plurality of light sensors arranged in a fixed position relative to a vehicle,
such that at least a first set of the plurality of light sensors is configured to measure light from the one or more outdoor lamps, and
at least a second set of the plurality of light sensors comprises at least two light sensors that are configured to detect the angle, which the light from the one or more outdoor lamps arrives at the second set of the light sensors, and
a processing unit configured to calculate the position relative to the vehicle of the one or more outdoor lamps based on the detected angle, which the light arrives at the second set of the light sensors,
wherein the processing unit is configured to calculate the light on the road based on the light measured in the fixed position relative to the vehicle and based on the calculated position of the one or more outdoor lamps.

2-14. (canceled)

15. The system according to claim 1, wherein the first set of the light sensors is configured to measure illuminance, spectral content, color, temperature, or color rendering index of the light or any combination thereof.

16. The system according to claim 1, wherein the second set of the light sensors comprises a quadro cell comprising an aperture configured to measure the angle which the light arrives at.

17. The system according to claim 1, wherein the second set of the light sensors comprises an imaging device configured to measure the angle which the light arrives at.

18. The system according to claim 1, wherein the first set of light sensors and the second set of light sensors are the same set.

19. The system according to claim 1, wherein the first set of light sensors and the second set of light sensors are different sets.

20. The system according to claim 1, wherein the first set and/or the second set of light sensors are attached to a bar or rod and, wherein the bar or rod is attached to the vehicle.

21. The system according to claim 1, wherein the system comprises a receiver for a space-based satellite navigation system configured to measure the position of the vehicle.

22. The system according to claim 1, wherein the system further comprises a camera configured to capture an image of the one or more outdoor lamps at a resolution allowing visual inspection of the one or more outdoor lamps.

23. The system according to claim 1, wherein the system is configured to provide an isolux curve associated with the calculated light on the road for each outdoor lamp.

24. The system according to claim 1, wherein the system is configured to provide a geomap associated with the calculated light on the road for each outdoor lamp.

25. The system according to claim 1, wherein the system is configured to compensate the calculated light from the outdoor lamp for light from other light sources.

26. A vehicle configured to move along a road, which comprises one or more outdoor lamps arranged along the road, the vehicle comprising:
a plurality of light sensors arranged in a fixed position relative to the vehicle,
such that at least a first set of the plurality of light sensors is configured to measure light from the one or more outdoor lamps,
and at least a second set of the plurality of light sensors comprises at least two light sensors configured to detect the angle which the light from the one or more outdoor lamps arrives at the second set of the light sensors,
wherein the first set and the second set of light sensors are configured to provide the measured light and measured angle as input to a system configured to measure light from the one or more outdoor lamps on the road, wherein the system comprises a processing unit and, wherein the processing unit is configured to calculate the position of the one or more outdoor lamps based on the detected angle, which the light arrives at the second set of the light sensors, and wherein the processing unit is configured to calculate the light on the road based on the light measured in the fixed position relative to the vehicle and based on the calculated position of the one or more outdoor lamps.

27. A method for measuring light from one or more outdoor lamps on a road using the system of claim 1, the method comprising:
measuring light from the one or more outdoor lamps using at least the first set of the light sensors;
detecting the angle, which the light from the one or more outdoor lamps arrives at the second set of light sensors, using at least the second set of the light sensors;
calculating the position of the one or more outdoor lamps based on the detected angle, which the light arrives at the second set of the light sensors, using the processing unit; and
calculating the light on the road based on the light measured in the fixed position relative to the vehicle and based on the calculated position of the one or more outdoor lamps using the processing unit.
